(19) United States
(12) Patent Application Publication
(10) Pub. No.: US 2021/0158810 A1
(43) Pub. Date: May 27, 2021

(54) VOICE INTERFACE FOR SELECTION OF VEHICLE OPERATIONAL MODES

(71) Applicant: GM Global Technology Operations LLC, Detroit, MI (US)

(72) Inventors: Eli Tzirkel-Hancock, Ra'anana (IL); Oana Sidi, Ramat Hasharon (IL)

(21) Appl. No.: 16/694,255

(22) Filed: Nov. 25, 2019

(51) Int. Cl. G10L 15/22; G10L 13/04; G10L 15/18; B60R 16/037

(52) U.S. Cl. CPC G10L 15/22; G10L 13/043; G05D 1/0088; B60R 16/0373; G10L 2015/223; G10L 15/1815

(57) ABSTRACT

Systems and methods performed in a vehicle involve obtaining a request generated from a voice command by an operator, the request being generated using speech recognition and the request being a selection of an operational mode of the vehicle. The method includes determining pre-settings required by the request, a specified order of activation required for the pre-settings, and whether the request is ready to initiate, the request requires one or more of the pre-settings to be activated, or the request is infeasible. The method also includes providing feedback to the operator based on a result of the determining, and issuing one or more instructions to implement the operational mode according to the request based on the result of the determining being that the request is ready to initiate.

### INTRODUCTION

The subject disclosure relates to a voice interface for selection of vehicle operational modes.

Vehicles (e.g., automobiles, trucks, construction equipment, farm equipment, automated factory equipment) have an increasing selection of autonomous or semi-autonomous operational modes. In addition, multiple modes of operation may be available for selection with many sub-options. For example, an operator may want the vehicle to enter an autonomous driving mode but may additionally want to specify that the vehicle should not perform an automated lane change. The activation of this type of operation requires a layered set of selections by the operator. When these selections are made by touchscreen or steering wheel-based inputs, for example, the process may become distracting and belabored. In addition, an operator-desired operational mode may not be available due to preconditions not being satisfied. The operator may not understand this based on traditional input mechanisms. Accordingly, it is desirable to provide a voice interface for selection of vehicle operational modes.

### SUMMARY

In one exemplary embodiment, a method performed in a vehicle includes obtaining a request generated from a voice command by an operator. The request is generated using speech recognition and the request being a selection of an operational mode of the vehicle. The method also includes determining pre-settings required by the request, a specified order of activation required for the pre-settings, and whether the request is ready to initiate, the request requires one or more of the pre-settings to be activated, or the request is infeasible. Feedback is provided to the operator based on a result of the determining, and one or more instructions are issued to implement the operational mode according to the request based on the result of the determining being that the request is ready to initiate.

In addition to one or more of the features described herein, the determining whether the request is ready to initiate is based on information from a drive controller.

In addition to one or more of the features described herein, the providing the feedback includes acknowledging the request based on the result of the determining being that the request is ready to initiate.

In addition to one or more of the features described herein, the determining the pre-settings includes the processor consulting a look up table of requests and corresponding pre-settings.

In addition to one or more of the features described herein, the determining whether the request requires the one or more pre-settings to be activated includes the processor checking one or more settings of other systems of the vehicle.

In addition to one or more of the features described herein, the providing the feedback includes requesting confirmation to set the one or more pre-settings based on the result of the determining being that the request requires the one or more pre-settings to be activated.

In addition to one or more of the features described herein, the issuing the one or more instructions to implement the operational mode includes activating the one or more pre-settings in the specified order.

In addition to one or more of the features described herein, the determining whether the request is infeasible is based on information from one or more sensors.

In addition to one or more of the features described herein, the providing the feedback includes indicating that the request will not be implemented based on the result of the determining being that the request is infeasible.

In addition to one or more of the features described herein, the method also includes generating the request from the voice command by using a speech recognition algorithm and by determining context for the voice command by tracking prior voice commands and the feedback, and implementing a text-to-speech algorithm to provide an audio output of the feedback to the operator.

In another exemplary embodiment, a system in a vehicle includes a speech recognition and interpretation module to generate a request from a voice command of an operator using a speech recognition algorithm, the request being a selection of an operational mode of the vehicle. The system also includes a processor to determine pre-settings required by the request, a specified order of activation required for the pre-settings, and whether the request is ready to initiate, the request requires one or more of the pre-settings to be activated, or the request is infeasible, to provide feedback to the operator based on the determination, and to issue one or more instructions to implement the operational mode according to the request based on the determination being that the request is ready to initiate.

In addition to one or more of the features described herein, the processor makes the determination that the request is ready to initiate based on information from a drive controller.

In addition to one or more of the features described herein, the feedback to the operator includes acknowledgment of the request based on the determination being that the request is ready to initiate.

In addition to one or more of the features described herein, the processor uses a look up table of requests and corresponding pre-settings to determine the pre-settings.

In addition to one or more of the features described herein, the processor determines the one or more pre-settings to be activated by checking one or more settings of other systems of the vehicle.

In addition to one or more of the features described herein, the feedback to the operator includes a request for confirmation to set the one or more pre-settings based on the determination being that the request requires the one or more pre-settings to be activated.

In addition to one or more of the features described herein, the processor issues the one or more instructions to implement the operational mode by activating the one or more pre-settings in the specified order.

In addition to one or more of the features described herein, the processor makes the determination that the request is infeasible based on information from one or more sensors.

In addition to one or more of the features described herein, the feedback includes an indication that the request will not be implemented based on the determination being that the request is infeasible.

In addition to one or more of the features described herein, the speech recognition and interpretation module determines a context for the voice command by tracking prior voice commands and the feedback, and the system also includes a text-to-speech module to implement a text-to-speech algorithm to provide an audio output of the feedback to the operator.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a vehicle with a voice interface for selection of operational modes;

FIG. 2 is a block diagram of components in the vehicle that facilitate a voice interface for selection of operational modes in the vehicle according to one or more embodiments; and

FIG. 3 is a process flow of a method of implementing a voice interface for selection of operational modes in a vehicle according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, vehicles may be available with multiple operational modes. The status and availability of modes are currently communicated through steering wheel color, the instrument cluster, audio, or haptic feedback, for example. User selections currently require layered inputs that are time-consuming and may be confusing. In addition, feedback regarding preconditions that must be met for certain driving modes may not be communicated clearly and effectively. That is, in order to select a given operational mode, the operator may have to make a number of selections, referred to herein as activating pre-settings (i.e., presets), in a particular order. The specific presets and the order in which they must be activated must be known to the operator according to prior systems.

Embodiments of the systems and methods detailed herein relate to a voice interface for selection of vehicle operational modes. The voice interface considers the context of the drive when communicating with the operator and functions as an intermediary between the operator and an automated drive controller of the vehicle. Because the voice interface facilitates the initiation of operational modes via voice commands by the operator without the operator knowing the presets, the voice interface gives rise to checks and interactions that are not necessary in a traditional system. That is, the voice interface, according to one or more embodiments, determines the presets that must be activated, and the order in which they must be activated, prior to activation of the selected operational mode. When input from the operator is needed to activate one or more of the presets, the voice interface interacts with the operator to work through the presets and to ultimately activate the operational mode requested by the voice command of the operator if possible.

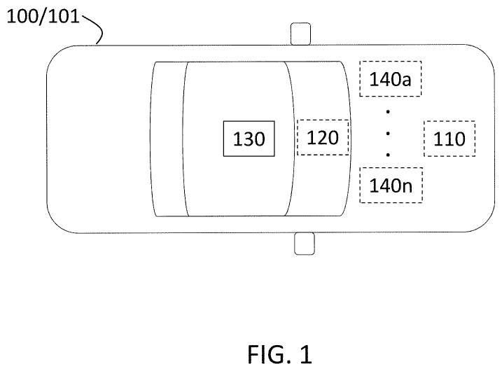

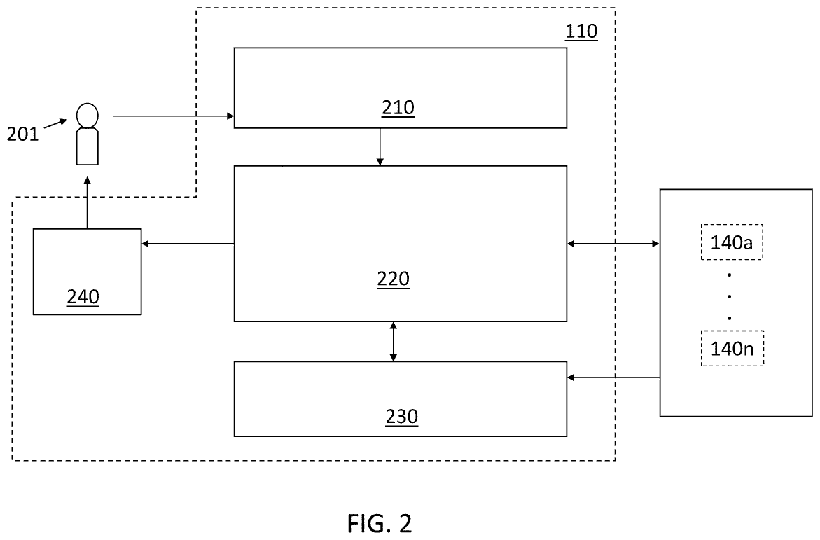

In accordance with an exemplary embodiment, FIG. 1 is a block diagram of a vehicle 100 with a voice interface for selection of operational modes. The exemplary vehicle 100 shown in FIG. 1 is an automobile 101. The vehicle 100 includes a controller 110 that may implement the functionalities of the voice interface 220 and the drive controller 230, as further discussed with reference to FIG. 2. A user interface 120 (e.g., infotainment system) facilitates voice input by the operator 201 (FIG. 2) (e.g., driver or other occupant of vehicle 100) and audio output to the operator 201. The vehicle 100 may include sensors 130 (e.g., radar system, lidar system, camera) that facilitate autonomous or semi-autonomous operation. The number and location of the sensors 130 are not intended to be limited by the exemplary illustration in FIG. 1. The sensors 130 may indicate road conditions and traffic conditions (e.g., lane lines are not visible, adjacent line is not clear) that facilitate determination of whether requested operational modes are feasible, as further discussed.

The vehicle 100 may also include a number of systems 140a through 140n (generally referred to as 140) such as a navigation system 140 and a configuration system 140. The navigation system 140 determines a location of the vehicle 100 and may generate mapping information to a destination indicated by the operator 201. The configuration system 140 maintains settings of the vehicle 100 (e.g., forward collision system setting, lane change setting, distance setting to preceding vehicle). The controller 110, as well as one or more systems 140, may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

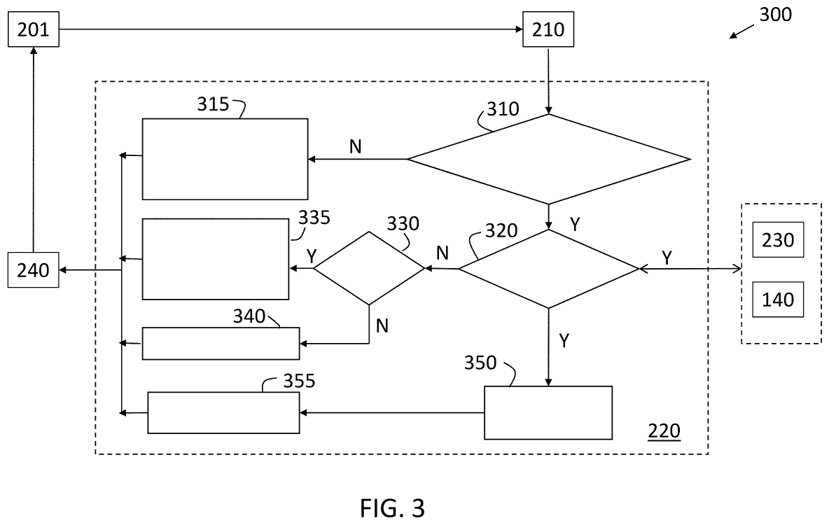

FIG. 2 is a block diagram of components in the vehicle 100 that facilitate a voice interface for selection of operational modes in the vehicle 100 according to one or more embodiments. A voice command by an operator 201 is received by a speech recognition and interpretation module 210. The speech recognition and interpretation module 210 implements a speech recognition algorithm and also determines the intent of the operator 201 based on context. According to one aspect, the speech recognition and interpretation module 210 tracks the entire dialogue (e.g., a set of commands from the operator 201 and responses to the operator 201) in order to determine the context of a subsequent voice command from the operator 201. For example, when the voice interface 220 provides a query (block 315, FIG. 3) to the operator 201, the response from the operator 201 will be understood to relate to the query. The speech recognition and interpretation module 210 is shown as being separate from the voice interface 220 because the speech recognition and interpretation module 210 may already be available in the vehicle 100 for interaction between the operator 201 and the infotainment system or other user interface 120. The specific functionality of the speech recognition and interpretation module 210 required for use with the voice interface 220 to control vehicle operational modes may be added to the existing component. In alternate embodiments, some or all of the functionality discussed for the speech recognition and interpretation module 210 may be implemented within the voice interface 220.

The voice interface 220 performs functionality to facilitate selection of vehicle operational modes by the operator 201 using the voice commands according to one or more embodiments. As further discussed with reference to FIG. 3, the voice interface 220 is not simply a translator that provides voice commands to the drive controller 230 for implementation of the selected mode. Because the operator 201 initiates interaction and need not have any prior knowledge of required presets (e.g., specific configuration, navigation input), the voice interface 220 must determine the presets required for the operational mode requested via the voice command or must determine that the operational mode requested via the voice command is not possible. This functionality does not exist and is not needed in traditional systems. That is, in a prior system, the operator 201 may consult a manual or other source to ascertain which presets are needed and the sequence by which presets must be activated to ultimately activate the desired operational mode. That information is now known by the voice interface 220, according to one or more embodiments. Thus, with a single voice command, the operator 201 may initiate a chain of presets in the requisite order by the voice interface 220. A request or response from the voice interface 220 to the operator 201 is provided as audio output using a text-to-speech module 240 that implements a text-to-speech algorithm.

The drive controller 230 tracks the drive state and changes operational modes of the vehicle 100 in communication with the voice interface 220, as indicated. As also indicated, the speech recognition and interpretation module 210, the voice interface 220, the drive controller 230, and the text-to-speech module 240 may be implemented by the controller 110 alone or in communication with other processing circuitry of the vehicle 100. The voice interface 220 determines whether an operational mode requested by the operator 201 via a voice command (e.g., “drive automatically but tell me before changing lanes”) can be initiated, cannot be initiated, or requires presets. The voice interface 220 makes the determination based on information from the drive controller 230 or other systems 140, as further discussed with reference to FIG. 3. As indicated in FIG. 2, the voice interface 220 can provide input to other systems 140 (i.e., can activate presets) as well as receive information from those other systems 140. As previously discussed, other systems 140 of the vehicle 100 may include a navigation system 140 and configuration system 140.

FIG. 3 is a process flow of a method 300 of implementing a voice interface for selection of operational modes in a vehicle 100 according to one or more embodiments. The flow begins with an instruction or voice command spoken by the operator 201 and recognized and interpreted by the speech recognition and interpretation module 210. At block 310, the voice interface 220 determines whether the request received via the speech recognition and interpretation module 210 is understood. This determination applies to multiple aspects of the request. For example, the requested action itself (e.g., “change lane”) must be among a set of known actions. The timing of the requested action (e.g., now, when feasible) must also be understood. For example, the voice command by the operator 201 may be “change lane” or “change lanes when you can.” The requested timing may affect feasibility of a request.

If any aspect of the request is not understood, then a query for more information is generated, at block 315. The query must be pertinent to the aspects that are not understood (e.g., “would you like to initiate the command now?”) rather than being generic. The query, like all outputs from the voice interface 220 to the operator 201, is provided to the text-to-speech module 240 to produce an audio output (e.g., via a user interface 120 like the infotainment system). A subsequent response from the operator 201 is interpreted in the context of the original request by the speech recognition and interpretation module 210. That is, as previously noted, the speech recognition and interpretation module 210 tracks an entire dialogue so that the context of the response to the query from the operator 201 is understood to relate to the previous request. If the request is determined to be understood (at block 310), then a check is performed at block 320.

At block 320, a check is done of whether the request is possible. This check includes a check of preconditions, which refers to presets as well as feasibility. For example, a “drive automatically” request may have two presets. One of the two presets of the “drive automatically” request may be that the forward collision avoidance setting must be set to alert and brake, and the other preset may be that the destination must be set in the navigation system 140. If either of the presets is not already activated, a request regarding the necessary preset may be issued at block 335. For example, the request at block 335 may be for the operator 201 to set a destination in the navigation system 140, because this is not information that the voice interface 220 can know without input from the operator 201.

While two exemplary presets are discussed, there may be additional presets and other preconditions. For example, information from one or more sensors 130 may indicate that the lane markings of the roadway are missing. Thus, an autonomous driving precondition may not be met. This is not a precondition that the operator 201 can affect but, instead, represents an infeasibility of the request. This infeasibility may be indicated to the voice interface 220 by the drive controller 230, which obtains the information from the sensors 130, for example. As another example, a “change lane” request may not require any presets but may not be feasible under the current traffic or road conditions (e.g., lane closed, lane lines not visible).

As indicated by the example, the check at block 320 may require interaction with the drive controller 230 to determine any necessary preconditions, as well as with other systems 140 (e.g., configuration system 140, navigation system 140) to determine the current status of the preconditions. In the exemplary case of the initial voice command being “drive automatically,” the communication between the voice interface 220 and the drive controller 230 may indicate that the forward collision avoidance setting is not already set to alert and brake. In addition, the communication between the voice interface 220 and the navigation system 140 may indicate that the destination is not already indicated to the navigation system 140.

If one or more presets are not activated or the request is not feasible, according to the check at block 320, then a check is done, at block 330, of whether the issue is a preset or feasibility (i.e., whether more is needed from the operator 201). If the operator 201 must confirm the activation of one or more presets, according to the check at block 330, then a request for confirmation is generated at block 335. Thus, in the exemplary case, at block 335, the voice interface 220 issues a request to the operator 201 to confirm whether the alert and brake setting of the forward collision avoidance may be activated and also a request to provide the destination to the navigation system 140. If, instead, the request is not feasible, according to the check at block 330, then a message is generated, at block 340, that the request cannot be performed. Whether the preset confirmation request (at block 335) or non-feasibility message (at block 340) are generated, they are provided to the text-to-speech module 240 for audio output to the operator 201.

If the check at block 320 indicates that all preconditions are met (i.e., presets are confirmed for activation or activated and the request is feasible), then the voice interface 220 activates the operational mode requested by the voice command of the operator 201 at block 350. The activation may involve communication with the drive controller 230 or other systems 140, for example. The activation at block 350 may involve multiple instructions from the voice interface 220 in a specific sequence to implement the operational mode requested in the initial voice command. Upon activation at block 350, the voice interface 220 may issue an acknowledgement at block 355 that is provided as audio output to the operator 201 via the text-to-speech module 240.

The activation stage, at block 350, may be reached during a second iteration. For example, according to the previously discussed case, a request for confirmation to preset the forward collision avoidance and for provision of the destination to the navigation system 140 are issued at block 335. Subsequently, the operator 201 response (e.g., confirming the forward collision avoidance setting to alert and brake) is received by the voice interface 220 via the speech recognition and interpretation module 210. As previously noted, the speech recognition and interpretation module 210 tracks the dialogue to understand that this response relates to the previous voice command (i.e., “drive automatically” according to the example). Then, the subsequent check, at block 320, indicates that all preconditions are met. Thus, the same voice command that resulted in requests (at block 335) in the previous iteration now proceeds to activation, at block 350. Thus, according to the example, the activation, at block 350, may include issuing an instruction to set the forward collision avoidance to alert and brake prior to issuing the instruction to ultimately implement driving automatically.

The voice interface 220 may implement the functionality detailed herein via a rule-based algorithm or through machine learning, for example. According to an exemplary embodiment, the voice interface 220 may match an incoming request with one among a list of requests and communicate with the drive controller 230 or other systems 140 based on a mapping of that request with preconditions (i.e., presets and feasibility assessments). That is, a look-up table may be consulted to determine the preconditions associated with the request according to an exemplary embodiment. The process flow shown in FIG. 3 may be modified in one or more ways to ensure that unintended operational modes are not initiated in the vehicle 100. For example, the operator 201 may have a push-to-talk button to initiate interaction to ensure that other occupants of the vehicle 100 do not initiate actions. Voice authentication may be used for the operator 201 instead. Explicit confirmation of requests may be required to initiate any actions, even after preconditions and feasibility are confirmed. Cancellation or correction of requests may be facilitated, as well.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method performed in a vehicle, comprising:
obtaining, at a processor, a request generated from a voice command by an operator, the request being generated using speech recognition and the request being a selection of an operational mode of the vehicle;
determining, by the processor, pre-settings required by the request, a specified order of activation required for the pre-settings, and whether the request is ready to initiate, the request requires one or more of the pre-settings to be activated, or the request is infeasible;
providing, from the processor, feedback to the operator based on a result of the determining; and
issuing one or more instructions to implement the operational mode according to the request based on the result of the determining being that the request is ready to initiate.

2. The method according to claim 1, wherein the determining whether the request is ready to initiate is based on information from a drive controller.

3. The method according to claim 1, wherein the providing the feedback includes acknowledging the request based on the result of the determining being that the request is ready to initiate.

4. The method according to claim 1, wherein the determining the pre-settings includes the processor consulting a look up table of requests and corresponding pre-settings.

5. The method according to claim 4, wherein the determining whether the request requires the one or more pre-settings to be activated includes the processor checking one or more settings of other systems of the vehicle.

6. The method according to claim 1, wherein the providing the feedback includes requesting confirmation to set the one or more pre-settings based on the result of the determining being that the request requires the one or more pre-settings to be activated.

7. The method according to claim 6, wherein the issuing the one or more instructions to implement the operational mode includes activating the one or more pre-settings in the specified order.

8. The method according to claim 1, wherein the determining whether the request is infeasible is based on information from one or more sensors.

9. The method according to claim 1, wherein the providing the feedback includes indicating that the request will not be implemented based on the result of the determining being that the request is infeasible.

10. The method according to claim 1, further comprising generating the request from the voice command by using a speech recognition algorithm and by determining context for the voice command by tracking prior voice commands and the feedback, and implementing a text-to-speech algorithm to provide an audio output of the feedback to the operator.

11. A system in a vehicle, comprising:
a speech recognition and interpretation module configured to generate a request from a voice command of an operator using a speech recognition algorithm, the request being a selection of an operational mode of the vehicle; and
a processor configured to determine pre-settings required by the request, a specified order of activation required for the pre-settings, and whether the request is ready to initiate, the request requires one or more of the pre-settings to be activated, or the request is infeasible, to provide feedback to the operator based on the determination, and to issue one or more instructions to implement the operational mode according to the request based on the determination being that the request is ready to initiate.

12. The system according to claim 11, wherein the processor is configured to make the determination that the request is ready to initiate based on information from a drive controller.

13. The system according to claim 11, wherein the feedback to the operator includes acknowledgment of the request based on the determination being that the request is ready to initiate.

14. The system according to claim 11, wherein the processor is configured to use a look up table of requests and corresponding pre-settings to determine the pre-settings.

15. The system according to claim 14, wherein the processor is configured to determine the one or more pre-settings to be activated by checking one or more settings of other systems of the vehicle.

16. The system according to claim 11, wherein the feedback to the operator includes a request for confirmation to set the one or more pre-settings based on the determination being that the request requires the one or more pre-settings to be activated.

17. The system according to claim 16, wherein the processor is configured to issue the one or more instructions to implement the operational mode by activating the one or more pre-settings in the specified order.

18. The system according to claim 11, wherein the processor is configured to make the determination that the request is infeasible based on information from one or more sensors.

19. The system according to claim 11, wherein the feedback includes an indication that the request will not be implemented based on the determination being that the request is infeasible.

20. The system according to claim 11, wherein the speech recognition and interpretation module is further configured to determine a context for the voice command by tracking prior voice commands and the feedback, and the system also includes a text-to-speech module configured to implement a text-to-speech algorithm to provide an audio output of the feedback to the operator.
